(19) United States
(12) Patent Application Publication
(10) Pub. No.: US 2023/0105099 A1
(43) Pub. Date: Apr. 6, 2023

(54) METHOD, APPARATUS, AND COMPUTER PROGRAM PRODUCT FOR DYNAMIC POPULATION ESTIMATION

(71) Applicant: HERE GLOBAL B.V., Eindhoven (NL)

(72) Inventors: Christian STADE-SCHULDT, Berlin (DE); Nicolas NEUBAUER, Berlin (DE); Dmitry KOVAL, Berlin (DE); Jerome BEAUREPAIRE, Berlin (DE)

(21) Appl. No.: 17/491,597

(22) Filed: Oct. 1, 2021

(51) Int. Cl. G06F 16/29; G06F 16/28; H04L 29/08; G06N 20/00

(52) U.S. Cl. CPC G06F 16/29; G06F 16/287; G06N 20/00; H04L 67/12

(57) ABSTRACT

Provided herein is a method for a framework to predict the population density for an area based on indirect measurements and contextually similar areas. Methods may include: receiving ground truth population data corresponding to a first region; determining map features associated with the first region; receiving dynamic mobility data associated with the first region; training a machine learning model based on the ground truth population data corresponding to the first region, the map features associated with the first region, and the dynamic mobility data associated with the first region; receiving dynamic mobility data associated with a second region; determining map features associated with the second region; processing the dynamic mobility data associated with the second region and the map features associated with the second region using the machine learning model; and receiving, from the machine learning model, a population estimate for the second region.

### TECHNOLOGICAL FIELD

Example embodiments described herein relate generally to determining dynamic population estimates for an area, and more particularly, to a framework to predict the population density for an area based on indirect measurements and contextually similar areas.

### BACKGROUND

Population estimation for a region is difficult based on the unique behavior of individuals within a population and often unpredictable movement. Census data provides population estimates for a region; however, census data is generally periodic, static population counts. Thus, census data only provides a static snapshot of population information. Further, census data does not provide information regarding where people actually are and instead relies upon residential addresses to establish head counts.

Population data is valuable for a variety of reasons ranging from democratic representation of a population to identifying where people are in order to target advertising. Further, population data over time reveals migratory patterns of people through a region. More frequent population data that changes over shorter periods of time may further be useful for a variety of reasons, including the planning of roadways or public transit, among other uses.

### BRIEF SUMMARY OF EXAMPLE EMBODIMENTS

At least some example embodiments are directed to determining dynamic population estimates for an area, and more particularly, to a framework to predict the population density for an area based on indirect measurements and contextually similar areas.Embodiments may provide an apparatus including at least one processor and at least one memory including computer program code, the at least one memory and the computer program code may be configured to, with the processor, cause the apparatus to at least: receive ground truth population data corresponding to a first region; determine map features associated with the first region; receive dynamic mobility data assocaited with the first region; train a machine learning model based on the ground truth population data corresponding to the first region, the map features associated with the first region, and the dynamic mobility data associated with the first region; receive dynamic mobility data associated with a second region; determine map features associated with the second region; process the dynamic mobility data associated with the second region and the map features associated with the second region using the machine learning model; and receive, from the machine learning model, a population estimate for the second region.

According to an example embodiment, the population estimate for the second region is determined by the machine learning model using map features within a predefined degree of similarity of the map features associated with the second region. The first region of some embodiments includes a first road segment, where the map features used to train the machine learning model include one or more of a functional classification of the road segment, a speed classification, a number of lanes, a direction of travel, an environmental context, points-of-interest proximate the road segment, or road segment length. The second region of some embodiments includes a road segment, where map features used by the machine learning model for the population estimate include one or more of a functional classification of the road segment, a speed classification, a number of lanes, a direction of travel, an environmental context, points-of-interest proximate the road segment, or road segment length, wherein the population estimate for the second region is generated by the machine learning model based on map features of the second road segment.

According to some embodiments, the ground truth population data corresponding to the first region includes dynamic ground truth population data and static ground truth population data, where dynamic ground truth population data includes population data corresponding to the first region that changes at least daily, where static ground truth population data includes population data corresponding to the first region that remains constant for at least a day. The dynamic mobility data associated with the first region includes, in some embodiments, at least one of: mobile device probe data, vehicle probe data, social media check-in data, traffic data, or camera image data. The apparatus of some embodiments is further caused to generate a graphical user interface of a geographic region including the second region, where the graphical user interface presents the second region of the geographic region and provides an indication of the population estimate for the second region. Causing the apparatus of some embodiments to process the dynamic mobility data associated with the second region and the map features associated with the second region using the machine learning model includes causing the apparatus to process the dynamic mobility data associated with the second region, the map features assocaited with the second region, and a time epoch using the machine learning model.

Embodiments provided herein include a computer program product including at least one non-transitory computer-readable storage medium having computer-executable program code instructions stored therein, the computer-executable program code instructions including program code instructions to: receive ground truth population data corresponding to a first region; determine map features associated with the first region; receive dynamic mobility data associated with the first region; train a machine learning model based on the gorund truth population data corresponding to the first region, the map features associated with the first region, and the mobility data assocaited with the first region; receive dynamic mobility data associated with a second region; determine map features associated with the second region; process the dynamic mobility data associated with the second region and the map features associated with the second region using the machine learning model; and receive, from the machine learning model, a population estimate for the second region.

According to some embodiments, the population estimate for the second region is determined by the machine learning model using map features within a predefined degree of similarity of the map features associated with the second region. The first region of some embodiments includes a first road segment, where the map features used to train the machine learning model include one or more of a functional classification of the road segment, a speed classification, a number of lanes, a direction of travel, an environmental conext, points-of-interest proximate the road segment, or road segment length. The second region of some embodiments includes a second road segment, where the map features used by the machine learning model for the population estimate include one or more of a functional classification of the road segment, a speed classification, a number of lanes, a direction of travel, an environmental context, points-of-interest proximate the road segment, or road segment length, wherein the population estimate for the second region is generated by the machine learning model based on map features of the second road segment.

The ground truth population data corresponding to the first region includes, in some embodiments, dynamic ground truth population data and static ground truth population data, where dynamic ground truth population data includes population data corresponding to the first region that changes at least daily, where static ground truth population data includes poulation data corresponding to the first region that remains constant for at least a day. The dynamic mobility data associated with the first region includes at least one of: mobile device probe data, vehicle probe data, social media check-in data, traffic data, or camera image data. Embodiments may include program code instructions to generate a graphical user interface of a geographic region including the second region, where the graphical user interface presents the second region of the geographic region and provides an indication of the population estimate for the second region. The program code instructions to process the dynamic mobility data assocaited with the second region and the map features associated with the second region using the machine learning model include program code instructions to process the dynamic mobility data associated with the second region, the map features associated with the second region, and a time epoch using the machine learning model.

Embodiments provided herein include a method including: receiving ground truth population data corresponding to a first region; determining map features associated with the first region; receiving dynamic mobility data associated with the first region; training a machine learning model based on the ground truth population data corresponding to the first region, the map features associated with the first region, and the dynamic mobility data associated with the first region; receiving dynamic mobility data associated with a second region; determining map features associated with the second region; processing the dynamic mobility data associated with the second region and the map features associated with the second region using the machine learning model; and receiving, from the machine learning model, a population estimate for the second region.

According to some embodiments, the population estimate for the second region is determined by the machine learning model using map features within a predefined degree of similarity of the map features associated with the second region. The first region includes a first road segment, where the map features used to train the machine learning model include one or more of a functional classification of the first road segment, a speed classification, a number of lanes, a direction of travel, an environmental conext, points-of-interest proximate the first road segment, or first road segment length. The second region of some embodiments includes a second road segment, where the map features used by the machine learning model for the pupulation estimate include one or more of a functional classification of the second road segment, a speed classification, a number of lanes, a direction of travel, an environmental context, point-of-interest proximate the second road segment, or second road segment length, where the population estimate for the second region is generated by the machine learning model based on map features of the second road segment.

According to some embodiments, the ground truth population data corresponding to the first region includes dynamic ground truth population data and static ground truth population data, where dynamic ground truth population data includes population data corresponding to the first region that changes at least daily, where static ground truth population data includes population data corresponding to the first region that remains constant for at least a day. The dynamic mobility data associated with the first region includes at least one of: mobile device probe data, vehicle probe data, social media check-in data, or camera image data.

Embodiments provided herein include an apparatus including: means for receiving ground truth population data corresponding to a first region; means for determining map features associated with the first region; means for receiving dynamic mobility data associated with the first region; means for training a machine learning model based on the ground truth population data corresponding to the first region, the map features associated with the first region, and the dynamic mobility data associated with the first region; means for receiving dynamic mobility data associated with a second region; means for determining map features associated with the second region; means for processing the dynamic mobility data associated with the second region and the map features associated with the second region using the machine learning model; and means for receiving, from the machine learning model, a population estimate for the second region.

According to some embodiments, the population estimate for the second region is determined by the machine learning model using map features within a predefined degree of similarity of the map features associated with the second region. The first region includes a first road segment, where the map features used to train the machine learning model include one or more of a functional classification of the first road segment, a speed classification, a number of lanes, a direction of travel, an environmental conext, points-of-interest proximate the first road segment, or first road segment length. The second region of some embodiments includes a second road segment, where the map features used by the machine learning model for the pupulation estimate include one or more of a functional classification of the second road segment, a speed classification, a number of lanes, a direction of travel, an environmental context, point-of-interest proximate the second road segment, or second road segment length, where the population estimate for the second region is generated by the machine learning model based on map features of the second road segment.

According to some embodiments, the ground truth population data corresponding to the first region includes dynamic ground truth population data and static ground truth population data, where dynamic ground truth population data includes population data corresponding to the first region that changes at least daily, where static ground truth population data includes population data corresponding to the first region that remains constant for at least a day. The dynamic mobility data associated with the first region includes at least one of: mobile device probe data, vehicle probe data, social media check-in data, or camera image data.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates a block diagram of sources of dynamic mobility data according to an example embodiment of the present disclosure;

FIG. 4 is a flowchart of a method for training a machine learning model for predicting population of a region according to an example embodiment of the present disclosure;

FIG. 5 is a flowchart of the machine learning model of FIG. 4 being used to process dynamic mobility data from a new region according to an example embodiment of the present disclosure;

FIG. 6 illustrates a sequence of operations in a pipeline for predicting population for an area based in indirect measurements and contextually similar areas where visualization can occur throughout the process according to an example embodiment of the present disclosure; and

FIG. 7 is a flowchart of another method for establishing the population estimate for a region according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods, apparatus and computer program products are provided in accordance with an example embodiment in order to dynamically estimate the population density for a road segment or a geographic sub-area using machine learning trained on ground truth information, road segment or area properties, and dynamic mobility information. Census data can only provide a snapshot of population information for geographical areas of a geographic region. However, dynamic population density estimatates for finite geographic sub-areas including temporal population shifts and movement can be useful to a variety of industries. Further, geographical areas may not correspond with geographic sub-areas. For example, a geographical area for static population data may include a zip code, a city, a county boundary, etc. A geographic sub-area may be more narrow, such as a neighborhood, a building within a city, or along a road segment, for example. Dynamic population density estimates may be useful for identifying locations for advertising, planning mass transit (e.g., routes and stops), evaluating locations for alternative transportation clustering (e.g., ride-share vehicles, bicycle/scooter stations, etc.), identifying emergency service coverage areas and needs, residential planning, etc. According to example embodiments provided herein, ground truth population data can be used with aggregated mobility data and map data (e.g., road network features, geographic sub-area features) to train a machine learning model to determine the estimated population density for a geographic sub-area. Embodiments combine dynamic input data (mobility data, ground truth population data) and static data (map data) to estimate the population density a geographic sub-area. This concept provides a nanocensus service that solves the prediction problem of how many people are estimated to be in a given area at a given time.

Embodiments provided herein predict population density for a given location or area. These areas will generally be described herein as geographic sub-areas, but can include any defined geographic location. For example, a road segment may be a geographic sub-area, where a population density along the road link is desired. Further, a geographic sub-area can be an intersection of a road network, a city block, a neighborhood, a business area, or the like. Embodiments described herein can employ geographic sub-areas defined by a user or predefined geographic sub-areas for which understanding the population density is desirable.

Ground truth population data may include both static and dynamic population data. Static ground truth population data, as described herein, may include data that is not real-time data and is only updated on a periodic basis. For example, census data may be updated every ten years, or census estimates may be generated every year to produce static population data for geographical areas of a geographic region. Static population data may include data other than census data, such as a population count of a neighborhood, building, or city that may be updated weekly, monthly, or annually, for example. Static data may be generated by a variety of means; however, static population data generally includes establishing population count based on residential addresses of the population such that the static population data does not reflect any movement of the population during a day/month/year. Static population may include population data that is updated only periodically, and less frequently than a predefined amount of time, such as weekly, monthly, yearly, or longer. Further, static population data may be generated for a geographic region and the static population data may be broken down within that region into geographical areas. These geographical areas may correspond to boundaries such as zip codes, cities, counties, or other defined boundaries, for example.

Dynamic ground truth population data may include data gathered by sources such as municipalities that monitor traffic counts through cameras or other sensors. Dynamic ground truth population data may further be generated from public or mass transit, such as by ridership counting and counting of boarding/departures at various stops for public/mass transit. Both static and dynamic ground truth population data can be gathred by example embodiments decribed herein and matched to geographic sub-areas or road segments for use with dynamic mobility data. Dynamic ground truth data is described herein as data that changes at least daily, while static ground truth data is described herein as data as data that remains constant for at least a day.

Dynamic mobility data may be generated by an identified location of a probe which may take the form of a device that can report location. Dynamic data is data that is regularly changing and is updated frequently, such as in real-time or periodically in terms of seconds, minutes, or hours, typically. An instance of probe information/data may comprise, among other information, location information/data, heading information/data, etc. For example, the probe information/data may comprise a geophysical location (e.g., latitude and longitude) indicating the location of the probe apparatus at the time that the probe information/data is generated and/or provided (e.g., transmitted). The probe information/data may optionally include a heading or direction of travel. In an example embodiment, an instance of probe information/data may comprise a probe identifier identifying the probe apparatus that generated and/or provided the probe information/data, a timestamp corresponding to when the probe information/data was generated, and/or the like. Further, based on the probe identifier and the timestamp, a sequence of instances of probe information/data may be identified. For example, the instances of probe information of data corresponding to a sequence of instances of probe information/data may each comprise the same probe identifier or an anonymized identifier indicating that the data is from the same, anonymous probe. In an example embodiment, the instances of probe information/data in a sequence of instances of probe information/data are ordered based on the timestamps associated therewith to form a path.

The gathered ground truth population data (both static and dynamic) and the dynamic mobility data may be associated with geographic sub-areas of a geographic region. Associating the ground truth population data and mobility data with a geographic sub-area may include matching a location of the data with the area represented by a geographic sub-area. As dynamic mobility data and dynamic ground truth population data may have a discrete locations associated with each data point or count, each data point or count may be individually available to associate with any arbitrary geographic division generated, such that a geographic sub-area boundary may be established and the dynamic mobility data within that boundary at a specific time period is associated with that geographic sub-area.

Static ground truth population data may be associated with a geographic area, such as a city, county, mailing (zip) code, etc. as described above. The static ground truth population data may be associated with the geographic area based on the location of the identified population, such as the residential addresses of a population. This geographic areas of static population data may not correspond to the geographical sub-areas of dynamic mobility or dynamic ground truth population data as the geographical sub-areas may be smaller and more focused. In such cases, when using a combination of static ground truth population data and dynamic data, the static ground truth population data may require re-association from the geographical areas to the geographic sub-areas. Such re-association may be performed based on housing density within a geographical area used to estimate how to divide and re-associate the static ground truth population data with geographical sub-areas. Other techniques may be used to sub-divide geographical areas in order to re-associate static ground truth population data of the geographical area to a geographic sub-area in order to generate more precise estimates of population within the smaller geographic sub-areas.

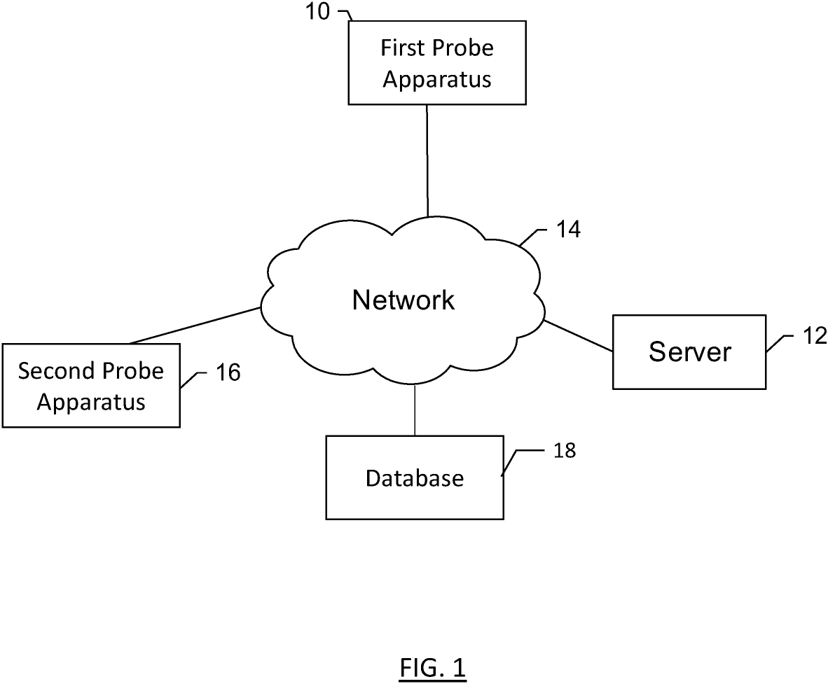

Referring now of FIG. 1, a system that supports communication, typically wirelessly, between a first probe apparatus 10, a second probe apparatus 16, a database 18, and a server 12 or other network entity (hereinafter generically referenced as a “server”) is illustrated. As shown, the probe apparatuses, database, and the server may be in communication via a network 14, such as a wide area network, such as a cellular network or the Internet or a local area network. However, the user devices and the server 12 may be in communication in other manners, such as via direct communications between a probe apparatus (e.g. probe apparatus 10 or 16) and the server 12, or direct communications between the probe apparatuses 10 and 16.

The probe apparatuses 10 and 16 may be embodied by a number of different devices including mobile computing devices, such as a personal digital assistant (PDA), mobile telephone, smartphone, laptop computer, tablet computer, vehicle navigation system, infotainment system, in-vehicle computer, or any combination of the aforementioned, and other types of voice and text communications systems. The server 12 may also be embodied by a computing device and, in one embodiment, is embodied by a web server. Additionally, while the system of FIG. 1 depicts a single server and two probe apparatuses, the system may include any number of servers and probe apparatuses, which may operate independently or collaborate to support activities of the probe apparatuses.

The database 18 may include one or more databases and may include information such as a map database in which geographic information may be stored relating to road networks, points-of-interest, buildings, etc. Further, the database may store therein static ground truth population data, such as census data relating to populations of geographical areas of a geographic region. The static ground truth population information may be provided by, for example, a municipality or governmental entity. The database may also include historical dynamic population data, such as historical traffic data, mobile device data, monitored area data (e.g., closed-circuit television), or the like. Thus, the database 18 may be used to facilitate the generation of dynamic probabilities of observing a predetermined number of people within a geographic area in conjunction with the server 12 and probe apparatuses 10 and 16.

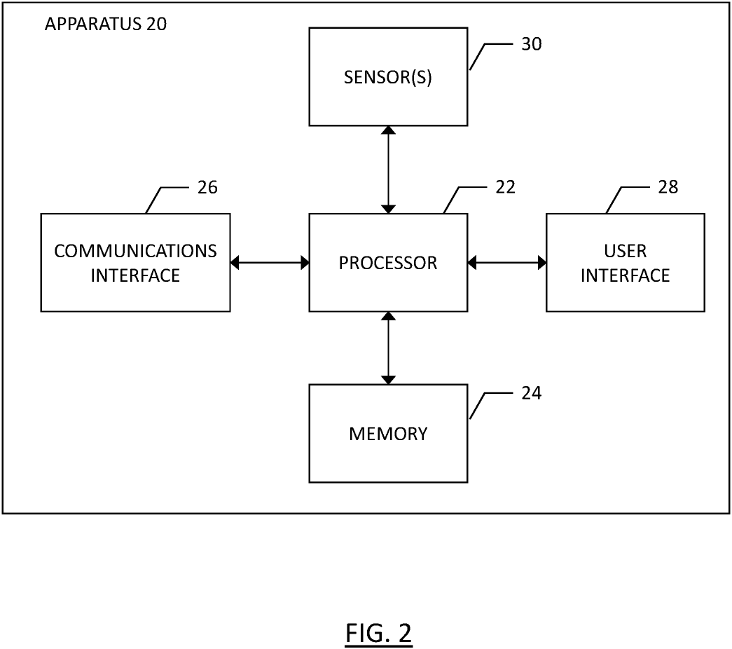

Regardless of the type of device that embodies the probe apparatuses 10 or 16, the probe apparatuses may include or be associated with an apparatus 20 as shown in FIG. 2. In this regard, the apparatus 20 may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus 20 to carry out various functions in accordance with an example embodiment of the present invention. For example, the memory device 24 could be configured to buffer input data for processing by the processor 22. Additionally or alternatively, the memory device could be configured to store instructions for execution by the processor.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor 22. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a head-mounted display) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22. In one embodiment, the processor 22 may also include user interface circuitry configured to control at least some functions of one or more elements of the user interface 28.

Meanwhile, the communication interface 26 may include various components, such as a device or circuitry embodied in either hardware or a combination of hardware and software that is configured to receive and/or transmit data between a computing device (e.g. user device 10 or 16) and a server 12. In this regard, the communication interface 26 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface 26 may be configured to communicate wirelessly with a head-mounted display, such as via Wi-Fi (e.g., vehicular Wi-Fi standard 802.11p), Bluetooth, mobile communications standards (e.g., 3G, 4G, or 5G) or other wireless communications techniques. In some instances, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms. For example, the communication interface 26 may be configured to communicate via wired communication with other components of a computing device.

The user interface 28 may be in communication with the processor 22, such as the user interface circuitry, to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface 28 may also be in communication with the memory 24 and/or the communication interface 26, such as via a bus.

The communication interface 26 may facilitate communication between different user devices and/or between the server 12 and user devices 10 or 16. The communications interface 26 may be capable of operating in accordance with various first generation (1G), second generation (2G), 2.5G, third-generation (3G) communication protocols, fourth-generation (4G), fifth-generation (5G) communication protocols, Internet Protocol Multimedia Subsystem (IMS) communication protocols (e.g., session initiation protocol (SIP)), and/or the like. For example, a mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols, fifth-generation (5G) wireless communicaiton protocols, and/or the like as well as similar wireless communication protocols that may be developed in the future.

The apparatus 20 of example embodiments may further include one or more sensors 30 which may include location sensors, such as a Global Navigation Satellite System (GNNS) sensors for the Global Positioning System (GPS), GALILEO, GLONASS or the like, sensors to detect wireless signals for wireless signal fingerprinting, sensors to identify an environment of the apparatus 20 such as image sensors for identifying a location of the apparatus 20, or any variety of sensors which may provide the apparatus 20 with an indication of location.

While the apparatus 20 is shown and described to correspond to a probe apparatus, embodiments provided herein may include a user device that may be used for a practical implementation of embodiments of the present disclosure. For example, such an apparatus may include a laptop computer, desktop computer, tablet computer, mobile phone, or the like. Each of which may be capable of providing a graphical user interface (e.g., presented via display or user interface 28) to a user for interaction with a map providing dynamic population density estimates for geographic sub-areas within a map as described further below. Embodiments of the user device may include components similar to those as shown in FIG. 2 through which a user may interact with dynamic population data presented on the display of a user interface for a device, such as apparatus 20.

Embodiments described herein relate to training a machine learning model based on ground truth population data, map data, and dynamic mobility data such that dynamic mobility data from an area may be used to generate a predicted population density for a geographic sub-area. By fusing available static and dynamic ground truth population data, mobility data, and map data about a geographic sub-area for a machine learning model, a population density for a geographic sub-area may be established where ground truth data is not available.

Static ground truth population data may be received from sources such as a census bureau, local, regional, or national governmental entities, or private population data collection/estimation services. This static ground truth population data may be indicative of a primary location of individuals of a population, such as their residential address. This data, while useful, does not provide sufficient detail with regard to the fluidity of the movement of people throughout a day, week, month, season, or year, for example.

Dynamic ground truth population data and dynamic mobility data may be gathered through various sources. For example, probe data from probes 20 may be collected from user’s mobile devices such as cell phones which can report location and movement of a user. This data may be real-time probe data or historical probe data from users. Other probes such as probes associated with vehicles may provide traffic data, which may also be real-time or historical traffic data. Historical traffic data can be considered dynamic population data as it tracks the ebb and flow of a population as it moves over short periods of time and for specific time instances. Thus, it is not static population data identifying a static, unchanging location of a person. Probe data provides accurate location through locationing mechanisms employed by the probes, which may include GPS sensors, wireless fingerprinting, access point identifiers, etc. Other dynamic population data may be collected through social media, such as through user check-ins at locations, users self-identifying locations or enabling location access within social media, attendance at events identified within social media, or the like.

Still further, dynamic ground truth population data may be provided by devices monitoring specific locations, such as closed-circuit television cameras or security cameras that capture individuals in the field of view and may recognize individual people through image recognition software to provide a count of population in a field of view or a count of population passing through a field of view, such as in a particular direction to capture movement of the population toward or away from a location. Dynamic ground truth population data may also be established by cameras on roadways such as at toll points along a roadway, along a road segment, or at an intersection. Other devices may be used to identify dynamic ground truth population such as near-field communication stations, such as radio-frequency identification antennas that may read the presence of a person through their identification, their mobile device, a key card, etc. Thus, data regarding dynamic population may be gathered from a wide variety of devices using infrastructure that is presently in place.

Using dynamic mobility data, in combination with map features and ground truth population data to generate an estimate of population density within a geographic sub-area at any given time may have an accuracy and quality defined by the frequency with which the dynamic ground truth population data and dynamic mobility data are updated. For example, dynamic mobility data updated every hour may not provide sufficient granularity to generate an accurate estimate of a population density within a geographic sub-area in fifteen minute increments. Increasing the frequency of update of the dynamic mobility data may increase the accuracy of the population density estimates and allow the analysis and review of population data within finer epochs. However, the frequency of dynamic mobility data updates may be balanced with bandwidth, storage capacity, processing capacity, or the like against the benefits of more frequently updated data.

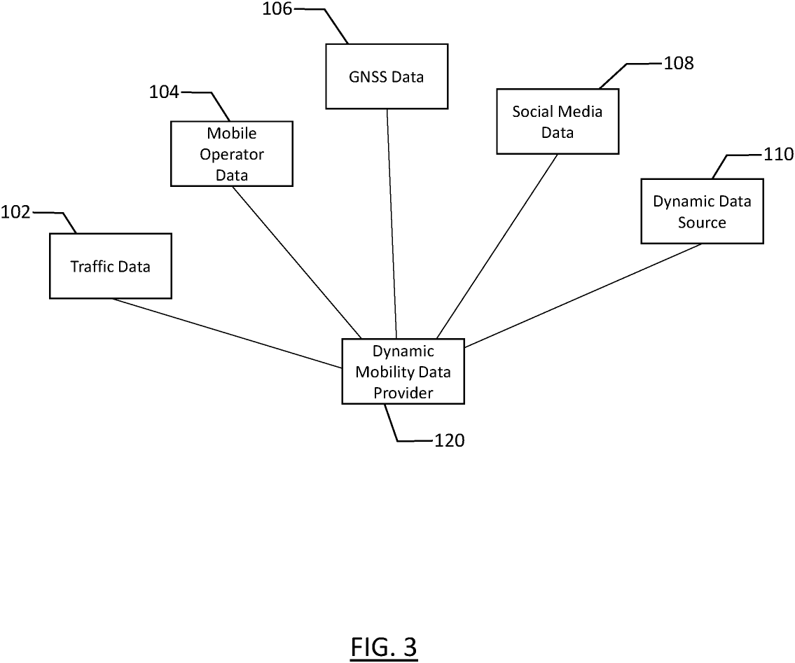

Embodiments of the present disclosure use static ground truth population data, dynamic ground truth population data, and dynamic mobility data together with features of map data in the area where the population and mobility data was gathered to build a model capable of providing improved estimates of population density where some data sources may not be available or may be of lower reliability. FIG. 3 illustrates an example embodiment of mobility data that may be gathered by a dynamic mobility data provider 120. The dynamic mobility data may be generated from traffic data 102, mobile operator data 104 (e.g., cell service provider), GNSS location data 106, social media data 108 (e.g., check-ins, reviews, etc.), or other dynamic data source 110. This data may be aggregated by the dynamic mobility data provider 120 and may in some cases be de-duplicated to reduce over-counting population.

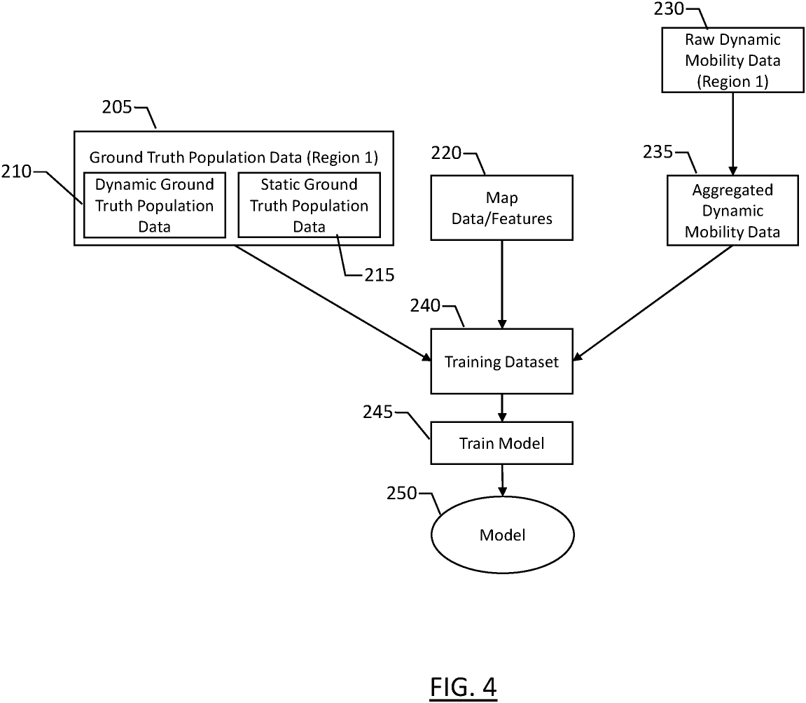

FIG. 4 illustrates machine learning model generation and training using ground truth population data 205 from a specific area (Region 1) including both dynamic ground truth population data 210 and static ground truth population data 215 from that area. The raw dynamic mobility data from the same area (Region 1) is received at 230, and aggregated at 235. Importantly, map data and features at 220 are determined and used in the training dataset. The specific area for this training data may include a geographic sub-area which is a region defined by a particular boundary, or a road segment, as described further below. The ground truth population data for a geographic sub-area or road segment can be established using the ground truth data, and the mobility data can identify dynamic population for a geographic sub-area or road segment; however, information pertaining to the specific geographic sub-area or road segment is needed to provide context to the ground truth and mobility data for training. Map data and features can be extracted from the database 18, for example, which may include a map database with information associated with map and map elements stored therein.

Features extracted for a specific road segment may include, for example, a functional classification, a speed classification (e.g., a speed range or a relative speed class (low, medium, high)), a number of lanes, direction of travel, environmental context (e.g., urban, rural, etc.), points-of-interest and proximity to the road segment, point-of-interest features (e.g., category, operating hours), map features proximate the road segment (e.g., parking lots, parking spaces, bodies of water, etc.), and road segment length. Additionally, dynamic map features may be used as training data, such as traffic patterns based on a time of day and day of week. Aggregated features of adjacent road segment can optionally be used to describe a single road segment. Further information pertaining to a road segment that may be extracted from map data and used for training purposes can include the proximity of mobility hubs (e.g., train stations, bus stations, bus stops, etc.), sidewalk width, street light presence, walkability scores (e.g., proximity to a variety of points-of-interest), noise level, pollution level, classification of area (e.g., industrial, commercial, residential), and other features of a road segment and proximate a road segment that provides information relevant to the road segment.

Embodiments provided herein may estimate population counts for geographic sub-areas in lieu of or in addition to road segments. Features extracted for a specific geographic sub-area may be similar to those extracted for a road segment; however, the features may be determined for a specific bounded area rather than along a particular road segment. For example, map features extracted for a geographic sub-area may include points-of-interest (categories, types, counts, etc.), point-of-interest features, type of location (residential, industrial, commercial, etc.), or accessibility of the geographic sub-area (e.g., reachable by walking, biking, driving, public transit, etc.). These extracted map features may be used as training data for the training dataset 240 for road segments and geographic sub-areas that are proximate or map-matched to the ground truth population data 205 and/or the aggregated dynamic mobility data 235.

The machine learning model is trained at 245 using the training data collected as identified above to establish the population for road segments and geographic sub-areas using the ground truth population data and aggregated mobility data, and to establish correlations and interrelations between map data and road network features with the population data. The dynamic mobility data gathered for an area can be noisy and can have considerably more variability than ground truth verified population counts. The ground truth verified population counts can be added to the training dataset to improve the accuracy of the model. The model is built using the training data to be able to accurately estimate the population for a road segment or a geographic sub-area.

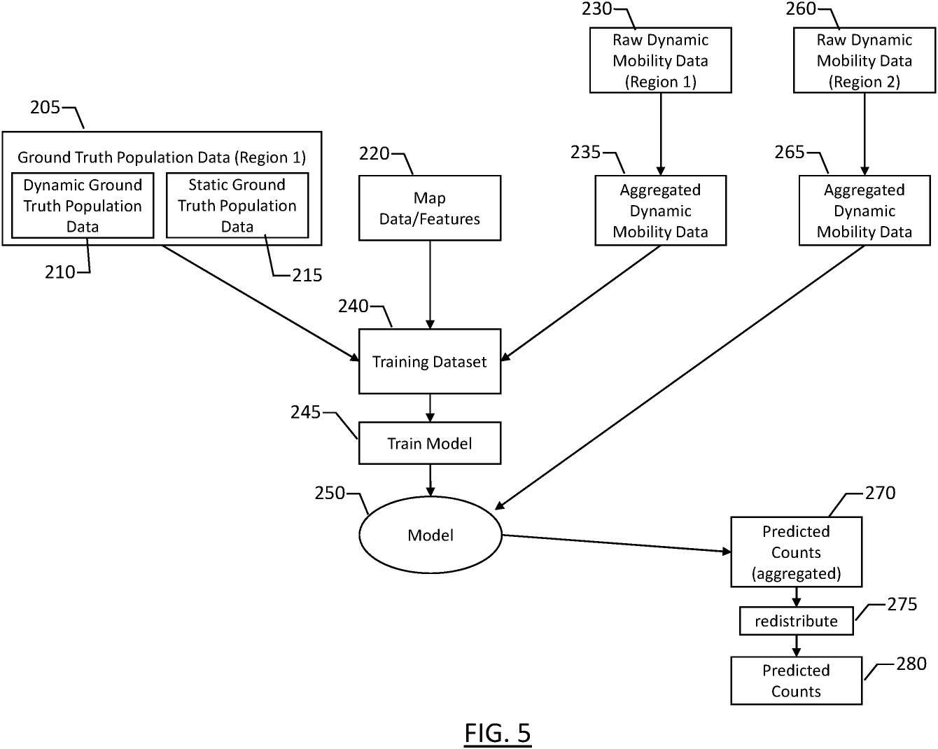

FIG. 5 illustrates an example embodiment of the model building/training of FIG. 4 together with the implementation of the model 250 using mobility data from a new or different region than the model was built with. As shown in FIG. 5, raw dynamic mobility data associated with another area (Region 2) is received at 260 and aggregated at 265. The aggregated dynamic mobility data for Region 2 is input into the machine learning model. Map data and features 220 may be identified that are associated with the location (e.g., geographic sub-area or road segment) and input to the model 250. Based on the trained model, the aggregated predicted population counts are ouput at 270, redistributed at 275 for the region and time epoch, and predicted counts are output at 280. The machine learning model uses, in some embodiments, map features that are determined to be within a predetermined degree of similarity of the map features associated with the input dynamic mobility data. The predetermined degree of similarity may include, for example, a count of POIs proximate the road segment or within the geographic sub-area being within a certain percentage of data on which the model is trained. A model trained with data including ground truth population data and dynamic mobility data from a geographic sub-area having 100 restaurants may be considered within a predefined degree of similarity of dynamic mobility input data from a geographic sub-area having 90 restaurants. The output can be in a variety of formats, such as a table or list that includes an identification of a geographic sub-area or road segment, a time bin, and an estimated population count for the respective geographic sub-area or road segment at the respective time bin.

The time bins, as described herein, are epochs or time windows such as one-hour blocks. Time bins can be longer or shorter, and may depend on the time bins used in the training data. While embodiments described herein predict population counts across different spatial regions, embodiments can predict population counts for unobserved time bins or time bins with insufficient data for a prediction. In this way, predictions for unobserved time bins may be scaled by their similarity in terms of day of the week, time, holiday, season, weather, etc.

The model, as trained by the training data described above, can be implemented as a global model, trained on global training data. However, in some embodiments, the model may be implemented as a local or regional model, trained on local or regional training data, respectively. Global models may be effective and with the benefit of vast amounts of training data, may be well informed and generally accurate predictors of population estimates. However, local or regional models may involve a sufficiently complex model with sufficient training data to adapt to location-based nuances in the data.

Example embodiments desribed above may be implemented for use in estimating the population within a geographic sub-area and/or along a road segment. Estimating the population within a geographic sub-area can be useful for a variety of use cases, such as marketing (e.g., billboards), transit planning, business development (e.g., planning restaurants or stores in high-density areas), or various other implementations. Estimating the population along a road segment may be useful for traffic planning and mitigation, travel time estimates, point-of-interest planning, marketing (e.g., billboards), and the like.

Embodiments described herein may be useful for a wide variety of practical implementations, such as for establishing where people are at a given time, or how people move throughout a day. Such information may be beneficial to advertisers so they understand where to target specific advertisements and at what times to do so. Other use cases may include aviation where a city may be sensitive to the noise generated by aircraft approaching and departing an airport due to noise issues. Embodiments may provide an indication of preferred flight paths where flight paths are more desirable to be over less-dense areas. Census data may suggest that populations are static in residential areas. However, embodiments described herein may demonstrate that it is undesirable to fly over businesses or industrial areas during the day, and instead to fly over residential areas of lower population to disrupt the fewest number of people. Embodiments may also be used to plan for emergency services and staffing such that emergency services proximate low population areas at certain times of the day may require lower staffing levels than during times of day in which those same areas have a high population.

Example embodiments provided herein may provide population estimates and predictions of a population within one or more geographic sub-areas and/or along road segments based upon mobility data, and may present this information on graphical user interfaces. The population estimates and predictions may also be queried live by third party systems that support the example use cases described above by an application programming interface such that the population estimates and predictions may be provided to third party systems without necessarily implementing a graphical user interface.

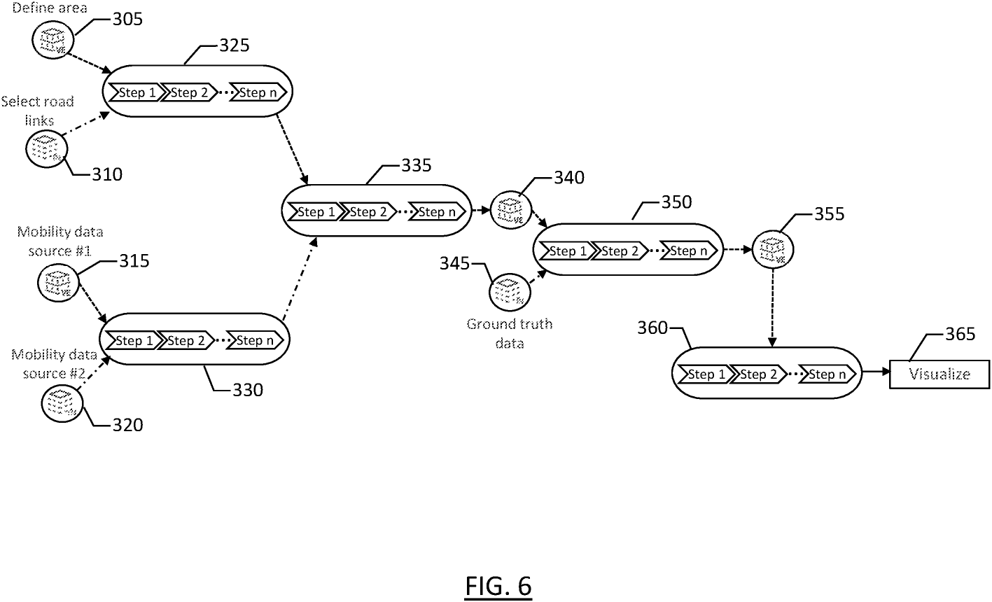

FIG. 6 illustrates a sequence of operations in a pipeline for predicting population for an area based in indirect measurements and contextually similar areas where visualization can occur throughout the process. As illustrated, a geographic area is defined at 305 and map data within that geographic area is identified. Road links or segments are selected at 310, and together with the defined geographic area, the area of interest is defined. Using the defined area and the selected road links, feature extraction occurs at 325 that defines the context of the defined area. The area of an example embodiment is defined at 305 by a user, such as through a user interface (e.g., user interface 28 of apparatus 20 of FIG. 2), by selecting an area of a map, a city, town, zip code, or other bounded area. Mobility data is gathered from multiple mobility data sources, such as mobility data source 1 at 315 and mobility data source 2 at 320. The mobility data is used at 330 to determine the population density within the defined area. The mobility data is aggregated with the map area and associated map data at 335 to produce mobility data for the defined area with the defined map properties at 340. Ground truth data 345 is combined with the map-associated mobility data and used to calibrate the mobility data as it relates to the map data relative to the ground truth data. The calibration process results in an accurate estimate of population for the defined area output at 355 with the population correlated to the defined area and the contextual information associated with the defined area. This data is optionally filtered at 360 and output at 365 for visualization, whereby a user may interact with the population data, such as via a user interface.

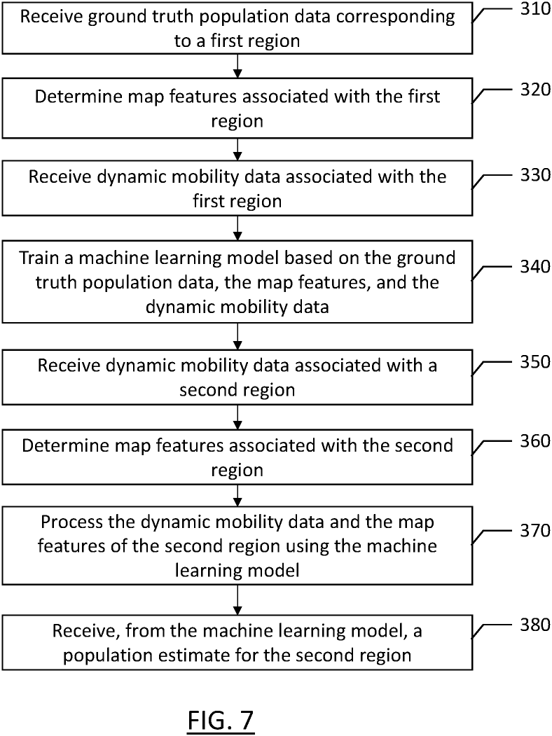

FIG. 7 illustrates a flowchart of a method for determining dynamic population estimates for an area, and more particularly, to a framework to predict the population density for an area based on indirect measurements and contextually similar areas according to an example embodiment of the present disclosure. As shown at 410, ground truth population data corresponding to a first region is received. Map features associated witht he first region are determined at 420, such as through a map database. Dynamic mobility data is received for the first region at 430. A machine learning model is trained at 440 based on the ground truth population data, the map features, and the dynamic mobility data. Dynamic mobility data associated with a second region is received at 450. Map features associated with the second region are determined at 460, such as using the map database. They dynamic mobility model data and the map features of the second region are processed using the machine learning model at 470. A population estimate is then received from the machine learning model as shown at 480.

As described above, FIG. 7 illustrates a flowchart of apparatuses 20, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 7 above may comprise a processor (e.g., the processor 22) configured to perform some or each of the operations (410-480) described above. The processor may, for example, be configured to perform the operations (410-480) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 410-480 may comprise, for example, the processor 22 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive ground truth population data corresponding to a first region;
determine map features associated with the first region;
receive dynamic mobility data associated with the first region;
train a machine learning model based on the ground truth population data corresponding to the first region, the map features associated with the first region, and the dynamic mobility data associated with the first region;
receive dynamic mobility data associated with a second region;
determine map features associated with the second region;
process the dynamic mobility data associated with the second region and the map features associated with the second region using the machine learning model; and
receive, from the machine learning model, a population estimate for the second region.

2. The apparatus of claim 1, wherein the population estimate for the second region is determined by the machine learning model using map features within a predefined degree of similarity of the map features associated with the second region.

3. The apparatus of claim 1, wherein the first region comprises a first road segment, wherein the map features used to train the machine learning model include one or more of a functional classification of the first road segment, a speed classification, a number of lanes, a direction of travel, an environmental context, points-of-interest proximate the first road segment, or first road segment length.

4. The apparatus of claim 3, wherein the second region comprises a second road segment, wherein the map features used by the machine learning model for the population estimate include one or more of a functional classification of the second road segment, a speed classification, a number of lanes, a direction of travel, an environmental context, points-of-interest proximate the second road segment, or second road segment length, wherein the population estimate for the second region is generated by the machine learning model based on map features of the second road segment.

5. The apparatus of claim 1, wherein the ground truth population data corresponding to the first region comprises dynamic ground truth population data and static ground truth population data, wherein dynamic ground truth population data comprises population data corresponding to the first region that changes at least daily, wherein static ground truth population data comprises population data corresponding to the first region that remains constant for at least a day.

6. The apparatus of claim 5, wherein the dynamic mobility data associated with the first region comprises at least one of: mobile device probe data, vehicle probe data, social media check-in data, traffic data, or camera image data.

7. The apparatus of claim 1, wherein the apparatus is further caused to generate a graphical user interface of a geographic region including the second region, wherein the graphical user interface presents the second region of the geographic region and provides an indication of the population estimate for the second region.

8. The apparatus of claim 1, wherein causing the apparatus to process the dynamic mobility data associated with the second region and the map features associated with the second region using the machine learning model comprises causing the apparatus to process the dynamic mobility data associated with the second region, the map features associated with the second region, and a time epoch using the machine learning model.

9. A computer program product comprising at least one non-transitory computer-readable storage medium having computer-executable program code instructions stored therein, the computer-executable program code instructions comprising program code instructions to:
receive ground truth population data corresponding to a first region;
determine map features associated with the first region;
receive dynamic mobility data associated with the first region;
train a machine learning model based on the gorund truth population data corresponding to the first region, the map features assocaited with the first region, and the mobility data assocaited with the first region;
receive dynamic mobility data associated with a second region;
determine map features associated with the second region;
process the dynamic mobility data associated with the second region and the map features associated with the second region using the machine learning model; and
receive, from the machine learning model, a population estimate for the second region.

10. The computer program product of claim 9, wherein the population estimate for the second region is determined by the machine learning model using map features within a predefined degree of similarity of the map features associated with the second region.

11. The computer program product of claim 9, wherein the first region comprises a first road segment, wherein the map features used to train the machine learning model include one or more of a functional classification of the first road segment, a speed classification, a number of lanes, a direction of travel, an environmental context, points-of-interest proximate the first road segment, or first road segment length.

12. The computer program product of claim 3, wherein the second region comprises a second road segment, wherein the map features used by the machine learning model for the population estimate include one or more of a functional classification of the second road segment, a speed classification, a number of lanes, a direction of travel, an environmental context, points-of-interest proximate the second road segment, or second road segment length, wherein the population estimate for the second region is generated by the machine learning model based on map features of the second road segment.

13. The computer program product of claim 9, wherein the ground truth population data corresponding to the first region comprises dynamic ground truth population data and static ground truth population data, wherein dynamic ground truth population data comprises population data corresponding to the first region that changes at least daily, wherein static ground truth population data comprises population data corresponding to the first region that remains constant for at least a day.

14. The computer program product of claim 13, wherein the dynamic mobility data associated with the first region comprises at least one of: mobile device probe data, vehicle probe data, social media check-in data, traffic data, or camera image data.

15. The computer program product of claim 1, further comprising program code instructions to generate a graphical user interface of a geographic region including the second region, wherein the graphical user interface presents the second region of the geographic region and provides an indication of the population estimate for the second region.

16. The computer program product of claim 9, wherein the program code instructions to process the dynamic mobility data associated with the second region and the map features associated with the second region using the machine learning model comprise program code instructions to process the dynamic mobility data associated with the second region, the map features associated with the second region, and a time epoch using the machine learning model.

17. A method comprising:
receiving ground truth population data corresponding to a first region;
determining map features associated with the first region;
receiving dynamic mobility data associated with the first region;
training a machine learning model based on the ground truth population data corresponding to the first region, the map features associated with the first region, and the dynamic mobility data associated with the first region;
receiving dynamic mobility data associated with a second region;
determining map features associated with the second region;
processing the dynamic mobility data associated with the second region and the map features associated with the second region using the machine learning model; and
receiving, from the machine learning model, a population estimate for the second region.

18. The method of claim 17, wherein the population estimate for the second region is determined by the machine learning model using map features within a predefined degree of similarity of the map features associated with the second region.

19. The method of claim 17, wherein the first region comprises a first road segment, wherein the map features used to train the machine learning model include one or more of a functional classification of the first road segment, a speed classification, a number of lanes, a direction of travel, an environmental context, points-of-interest proximate the first road segment, or first road segment length.

20. The method of claim 18, wherein the second region comprises a second road segment, wherein the map features used by the machine learning model for the population estimate include one or more of a functional classification of the second road segment, a speed classification, a number of lanes, a direction of travel, an environmental context, points-of-interest proximate the second road segment, or second road segment length, wherein the population estimate for the second region is generated by the machine learning model based on map features of the second road segment.
